(19) United States
(12) Patent Application Publication
(10) Pub. No.: US 2015/0227208 A1
(43) Pub. Date: Aug. 13, 2015

(54) Gesture Based Rating System and Method

(71) Applicant: Google Inc., Mountain View, CA (US)

(72) Inventors: Gregory M. Blevins, San Francisco, CA (US); Andrew T. Syzbalski, San Francisco, CA (US)

(21) Appl. No.: 13/718,193

(22) Filed: Dec. 18, 2012

(51) Int. Cl. G06F 3/01

(52) U.S. Cl. CPC G06F 3/017

(57) ABSTRACT

A method that includes receiving a request to provide a rating for an entity, in response to receiving the request to provide a rating for an entity, providing a graphical user interface comprising a gesture input region, receiving, via the gesture input region, a graphical representation of a gesture, determining a rating corresponding to the graphical representation of the gesture, and storing the rating.

### BACKGROUND OF THE INVENTION

1. Field of the Invention

This invention relates generally to rating techniques and more particularly to rating techniques employing graphical representation of gestures.

2. Description of the Related Art

Rating systems are often relied on by persons to educate themselves about other users' experiences with products, services, and so forth. For example, some persons rely on ratings when making a determination of what item to purchase, where to dine, where to vacation and so forth. Many rating systems include numeric style rating scales, such as a scale of one to five stars, with five stars being indicative of a highly positive rating. In the context of hotels, for example, a five star hotel rating may indicate that the hotel is viewed favorably by most, if not all, of the reviewers. Often these ratings are based on reviews submitted by numerous reviewers. For example, a rating provider may collect reviews for a given entity (e.g., an item, restaurant, hotel, service provider, or the like), and based on the reviews, generate a corresponding rating that is provided to other users to guide their decisions with regard to the entity.

Unfortunately, such rating systems can cause confusion for some users. For example, although a five star rating may be interpreted as a positive rating by the population in one region, it may be viewed as a negative rating by another population in a different region (e.g., a region where a lower number, such as a one star rating, relates to a positive experience). As a result users can be confused by variations from one rating system to another. Such confusion may be increased by the global nature of the Internet and other forms of communications that promote interaction of persons from all over the world, with differing interpretations of rating systems. Unfortunately, the confusion may also inadvertently skew ratings, rendering them less reliable to users. For example, reviewers accustomed to a lower number indicating a positive experience may rate a hotel with a single star, indicative of a low satisfaction rating within the rating system, despite the reviewer's intention to rate the hotel with the highest satisfaction rating. In addition to these shortcomings, users may forgo providing ratings altogether due to the bland nature of rating systems (e.g., rating systems based on stars, numbers or similar indicia). For example, a rating system may not invoke a user's interest and, as a result, the user may refrain from submitting a review and/or the ratings may be ignored.

### SUMMARY OF THE INVENTION

Various embodiments of methods and apparatus for gesture based rating techniques are provided herein. In some embodiments, provided is a method that includes receiving a request to provide a rating for an entity, in response to receiving the request to provide a rating for an entity, providing a graphical user interface comprising a gesture input region, receiving, via the gesture input region, a graphical representation of a gesture, determining a rating corresponding to the graphical representation of the gesture, and storing the rating.

In some embodiments, provided is a non-transitory computer readable storage medium having computer-executable program instructions stored thereon, that are executable by a computer to cause receiving a request to provide a rating for an entity, in response to receiving the request to provide a rating for an entity, providing a graphical user interface comprising a gesture input region, receiving, via the gesture input region, a graphical representation of a gesture, determining a rating corresponding to the graphical representation of the gesture, and storing the rating.

In some embodiments, provided is a rating system that includes a processor, a memory, and a processing module stored on the memory. The processing module to be executed by the processor to cause receiving a request to provide a rating for an entity, in response to receiving the request to provide a rating for an entity, providing a graphical user interface comprising a gesture input region, receiving, via the gesture input region, a graphical representation of a gesture, determining a rating corresponding to the graphical representation of the gesture, and storing the rating.

### BRIEF DESCRIPTION OF THE DRAWINGS

FIG. 1 is a diagram that illustrates a rating environment in accordance with one or more embodiments of the present technique.

FIG. 2 is a flowchart that illustrates a method of obtaining rating information in accordance with one or more embodiments of the present technique.

FIG. 3 is an illustration of an exemplary webpage including a gesture input interface in accordance with one or more embodiments of the present technique.

FIGS. 4A-4F are illustrations of various graphical representations of facial gestures in accordance with one or more embodiments of the present technique.

FIGS. 5A-5C are diagrams that illustrate exemplary geometric attributes of gestures of FIGS. 4E, 4A and 4D, respectively, in accordance with one or more embodiments of the present technique.

FIG. 6 depicts an index specifying exemplary relationships between geometric attributes, descriptions and rating values in accordance with one or more embodiments of the present technique.

FIG. 7A is a flowchart that illustrates a method of determining an overall rating in accordance with one or more embodiments of the present technique.

FIG. 7B depicts an index including ratings for a plurality of different entities obtained via different rating techniques s in accordance with one or more embodiments of the present technique

FIG. 8 is an illustration of an exemplary webpage including rating information in accordance with one or more embodiments of the present technique.

FIG. 9A is a flowchart that illustrates a method of displaying rating information in accordance with one or more embodiments of the present technique.

FIG. 9B is a diagram that illustrates a gesture/rating look-up table in accordance with one or more embodiments of the present technique.

FIG. 10 is a diagram that illustrates an exemplary computer system in accordance with one or more embodiments of the present technique.

### DETAILED DESCRIPTION OF THE PREFERRED EMBODIMENTS

As discussed in more detail below, provided in some embodiments are systems and methods for rating based on graphical representations of gestures. In some embodiments, a rating interface provides a user with an opportunity to sketch or otherwise define a gesture (e.g., a smile or frown) that is indicative of a rating for an entity (e.g., a thing such as an item, restaurant, hotel, service provider, or the like). In some embodiments, the rating interface includes a free-form box that enables a user to sketch a gesture corresponding to their level of satisfaction with an entity. In certain embodiments, the rating interface includes a pre-defined graphical representation of a gesture that can be manipulated by the user to re-define the graphical representation of the gesture. In certain embodiments, a rating system assesses various aspects of the user-defined gesture to determine a rating (“gesture rating”) corresponding thereto. In some embodiments, a rating is based on one or more geometric aspects of the user-defined gesture. In certain embodiments, a rating corresponding to a smile or frown is based on a direction of curvature, height, width, and/or angle of the user-defined gesture. In some embodiments, user-defined gestures are received from a plurality of different users and a combined rating is based on one or more of the user-defined gestures and/or associated ratings. In certain embodiments, an overall/combined rating is based on a geometric combination (e.g., a best-fit curve) of a plurality of different user-defined gestures. In some embodiments, gesture rating information corresponding to one or more ratings and/or one or more combined ratings are provided to a user such that the user may identify a rating corresponding to the entity. In certain embodiments, the gesture rating information includes a graphical representation of a gesture (e.g., a smile or frown) that corresponds to a determined rating.

A rating may include an indication of a user's opinion regarding their experience with a product, item, restaurant, hotel, service, transaction, website, or other entity. In some embodiments, a rating may correspond to a graphical representation of a gesture that is indicative of user's satisfaction with an entity. A gesture provided by a user may include a graphical representation of a smile or frown. For example, a user that is satisfied with an entity may provide a smile as the indicia of their rating for the entity. Conversely, a user that is dis-satisfied with an entity may provide a frown as the indicia of their rating for the entity. In some embodiments, a higher level of satisfaction may be associated with a larger, more pronounced smile, whereas a lower level of satisfaction may be associated with a larger, more pronounced frown. Thus, a user may be able to provide an indication of their level of satisfaction or dis-satisfaction with a given entity by simply providing a gesture, such as a smile or frown. Although several embodiments are described herein with regard to facial gestures, including a smile/frown, other embodiments may include other forms of gestures, such as a thumbs-up/thumbs-down. In some embodiments, a gesture may include or otherwise be accompanied by reviewing information. For example, a user may provide a graphical representation of a gesture (e.g., a smile/frown), and/or textual comments relating thereto (e.g., “Service was great and the rooms were very clean . . . ”).

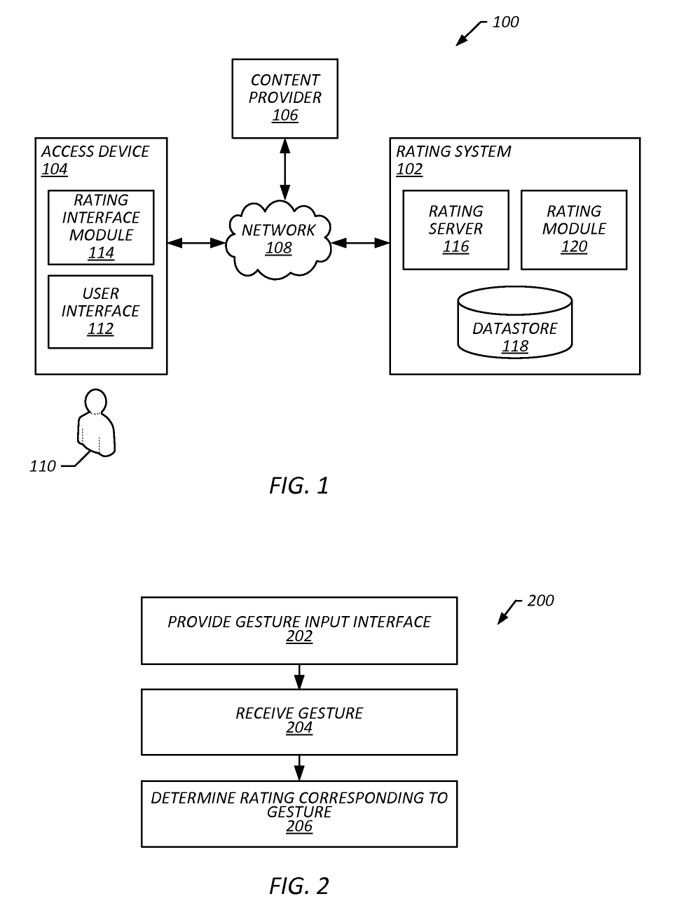

FIG. 1 is a diagram that illustrates a rating environment 100 in accordance with one or more embodiments of the present technique. In the illustrated embodiment, rating environment 100 includes a rating system 102, access device 104 and content provider 106. Entities of environment 100 (e.g., rating system 102, access device 104 and content provider 106) may be communicatively coupled to one another via a network 108.

Rating environment 100 may provide for user input of gestures indicative of a rating (e.g., gesture rating) and/or processing of gestures to generate corresponding ratings. For example, a user 110 may be provided an opportunity to input a gesture (e.g., a smile/frown) indicative of a rating of a given entity (e.g., a thing such as an item, restaurant, hotel, service provider, or the like) via access device 104, and the gesture may be processed to identify a corresponding gesture rating. Rating system 102 may combine the rating with other ratings for a given entity to generate an overall/combined rating for the given entity. In some embodiments, graphical illustrations of gestures corresponding to ratings for an entity may be presented to users to provide them with an indication of other users' rating of the entity. For example, in response to receiving a request from user 110 to view a rating for a given entity, a corresponding gesture indicative of one or more ratings by other users may be displayed to user 110 via access device 104.

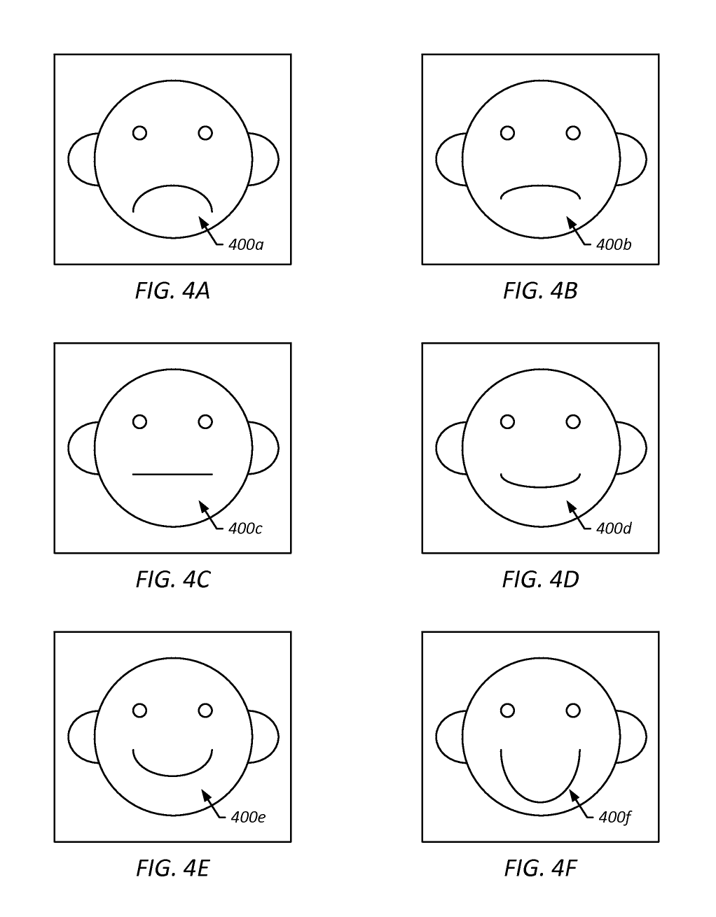

Rating system 102 may process a gesture to generate or otherwise identify a corresponding rating. A rating may include a numeric value or other indicia corresponding to a gesture. For example, a smile may correspond to a first rating (e.g., a rating of “3”), whereas a frown may correspond to a second rating (e.g., a rating of “1”). In some embodiments, a rating may be based on characteristics/attributes of a gesture (e.g., size, curvature, or the like), as discussed in more detail below with regard to at least FIGS. 4A-6. In some embodiments, an overall rating for an entity may be generated by combining two or more ratings corresponding to the entity. For example, where ratings of “1” and “3” for “XYZ Hotel” have been identified, an overall rating of “2” for the XYZ Hotel may be identified by averaging the ratings of “1” and “3”.

Rating system 102 may provide rating information (e.g., one or more ratings, combined ratings and/or associated reviews/comments) for review by various users. In some embodiments, rating system 102 may transmit rating information in response to a corresponding request for rating information. For example, where a given user 110 submits a request to view a travel webpage that includes a rating and/or review of a hotel, rating system 102 may transmit webpage content that includes corresponding rating information (e.g., a graphic illustration of a gesture corresponding to a rating of the hotel) and is displayed to user 110 via access device 104.

Network 108 may include any element or system that facilitates communications among and between various network entities/nodes of rating environment 100, such as rating system 102, access device 104 and content provider 106. Network 108 may include an electronic communication network, such as the Internet, a local area network (LAN), a wide area (WAN), a cellular communications network or the like. Network 108 may include a single network or combination of networks that facilitate communication between the entities of system 100. Network 108 may facilitate data exchange by way of packet switching using the Internet Protocol (IP). Network 108 may facilitate wired and/or wireless connectivity and communication.

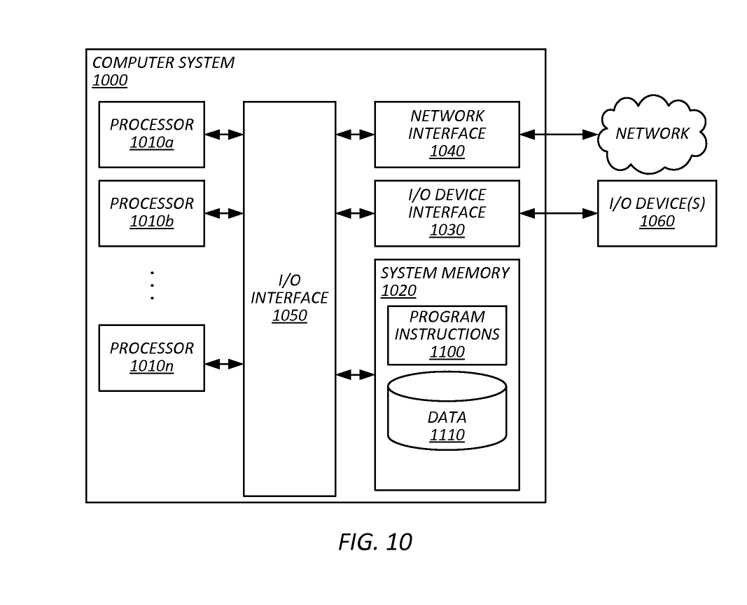

Access device 104 may include any device capable of transmitting and/or receiving information via network 108. Access device 104 may include a device employed by user 110 to interact with other entities/nodes coupled to network 108. For example, access device 104 may include one or more of a personal computer (e.g., a desktop), a mobile computing device (e.g., a laptop computer), a cellular communication device (e.g., a cellular phone), a personal digital assistant (PDA), a media player/recorder, a game console, a television system, an audio system, a radio system, a navigation system, or the like. In some embodiments, access device 104 includes a wired or wireless device. For example, access device 104 may include a cellular phone wirelessly connected to other devices of network 108 via a cellular communications network. A wireless access device 104 may enable user 110 to access network 108, and entities connected thereto, from a variety of remote locations. Access device 104 may include general computing components and/or embedded systems optimized with specific components for performing specific tasks. Access device 104 may include a program/application that can be used to generate a request for content, to provide content, to render content, and/or to send/receive requests to other devices via network 108. For example, access device 104 may store and/or execute an Internet web-browser or similar application. Such an application may be used to transmit and/or receive data and/or content via network 108, render data and/or content at access device 104, and/or enable user interaction with data and/or content via access device 104. Access device 104 may include a computer system similar to that of computer system 1000 described below with regard to at least FIG. 10.

Access device 104 may include a user interface 112 that provides for the exchange of information with a user 110. User interface 112 may include an output interface that enables data or other information to be provided to user 110. For example, user interface 112 may include a graphical user interface (e.g., a display screen), an audible user interface (e.g., a speaker), a print interface (e.g., a printer), or the like. User interface 112 may include an input interface that enables data or other information to be received from user 110. For example, user interface 112 may include a keyboard, a pointer device (e.g., mouse, trackball, touchpad, stylus), a graphical user interface (e.g., a touchscreen), an audible interface (e.g., a microphone), or the like.

Access device 104 may include a rating interface module 114. Rating interface module 114 may include program instructions that are executable to provide some or all of the functionally described herein with regard to access device 104. Rating interface module 114 may include a single module, or a plurality of different modules.

Content provider 106 may include an entity that provides content to various entities and users of rating environment 100. Content provider 106 may provide for the transmission of content and/or request via network 108. In some embodiments, content provider 106 hosts a content site, such as a website, a file transfer protocol (FTP) site, or other source of content accessible via network 108. For example, content provider 106 may include one or more web servers having webpages (e.g., webpages of a website) stored thereon. Content provider 106 may provide content to various entities of rating environment 100 in response to receiving a corresponding request/query. For example, in response to receiving, from access device 104, a user initiated request for a webpage, content provider 106 may transmit, via network 108, a corresponding HTML file for the webpage. The HTML file may be executed by a browser application or similar application of access device 104, and/or rendered for display to user 110 via a graphical user interface 112 of access device 104. Content provider 106 may include a computer system similar to that of computer system 1000 described below with regard to at least FIG. 10.

Rating system 102 may provide for the display of an interface for receiving a gesture from a user, for processing gesture/rating information, and/or for providing gesture/rating information to users for review. In some embodiments, rating system 102 may include a rating server 116, a datastore 118, and/or rating module 120. Rating module 120 may include program instructions that are executable to provide some or all of the functionally described herein with regard to rating system 102. Rating module 112 may include a single module, or a plurality of different modules. Rating system 102 may include a computer system similar to that of computer system 1000 described below with regard to at least FIG. 10.

Datastore 118 may include a data repository, such as a computer memory or database. Datastore 118 may include a database or other memory location storing data used by rating server 116 to respond to network requests, data used by rating module 120 for various processing tasks, or the like. Datastore 118 may store rating information and/or code corresponding to rating module 120.

Rating server 116 may provide a network interface for rating system 102. Rating server 116 may host data and/or applications that can be used to serve client requests. For example, rating server 116 may include data and/or applications that provide for the receipt and processing of requests received via network 108. In some embodiments, rating server 116 may direct requests to appropriate portions of rating system 102 for processing. For example, upon receiving a request that requires access to data that is not stored on rating server 116 and/or processing by an application/module that is not located on rating server 116, rating server 116 may coordinate the routing of requests and data between appropriate portions of rating system 102 and/or other systems of network 108.

Although rating server 116 is represented by a single box in FIG. 1, rating server 116 may include a single server or similar system, or a plurality of servers and/or similar systems. For example, rating server 116 may include a plurality of different servers and/or similar systems that may be employed individually and/or in combination to perform some or all of the functionality described herein with regard to rating server 116.

In some embodiments, rating environment 100 provides for receiving gestures from one or more users and/or generating a corresponding rating based on the received gesture. For example, where a content page that includes a section for providing a rating of a given entity is to be displayed to user 110 via user interface 112 of access device 104, rating system 102 may provide a corresponding gesture input interface that enables a user to define or otherwise provide a gesture (e.g. a smile or frown) corresponding to the user's rating for the given entity. In some embodiments, a gesture may be processed to generate a corresponding rating. For example, features of a smile sketched and submitted by a user 110 via a gesture input interface may be processed to determine a corresponding rating. In some embodiments, a rating may be determined locally. For example, access device 104 may process the received gesture to generate a corresponding rating that is subsequently transmitted to rating system 102. Such embodiments may help to reduce data transferred to rating system 102 as the rating may be transmitted to rating system 102 as opposed to a set of data (e.g., an image) representative of the gesture itself. In some embodiments, a rating may be determined remotely. For example, a gesture may be received at access device 104, gesture data indicative of the graphical representation of the gesture (e.g., an image) may be transmitted from the access device 104 to rating system 102, and rating system 102 may process the received gesture data to generate a corresponding rating. Such an embodiment may preserve gesture data for other processing by various portions of rating system 102.

FIG. 2 is a flowchart that illustrates a method 200 of obtaining rating information in accordance with one or more embodiments of the present technique. Method 200 may generally include providing a gesture input interface, receiving a gesture, and determining a rating corresponding to the gesture.

Method 200 may include providing a gesture input interface, as depicted at block 202. Providing a gesture input interface may include providing a gesture input region that enables a user to provide a graphical representation of a gesture. In some embodiments, providing a gesture input interface may include displaying to user 110 via user interface 112 of access device 104, a webpage or similar content page that includes a region in which a user may sketch or otherwise define a graphical representation of a smile or frown indicative of a rating of a given entity.

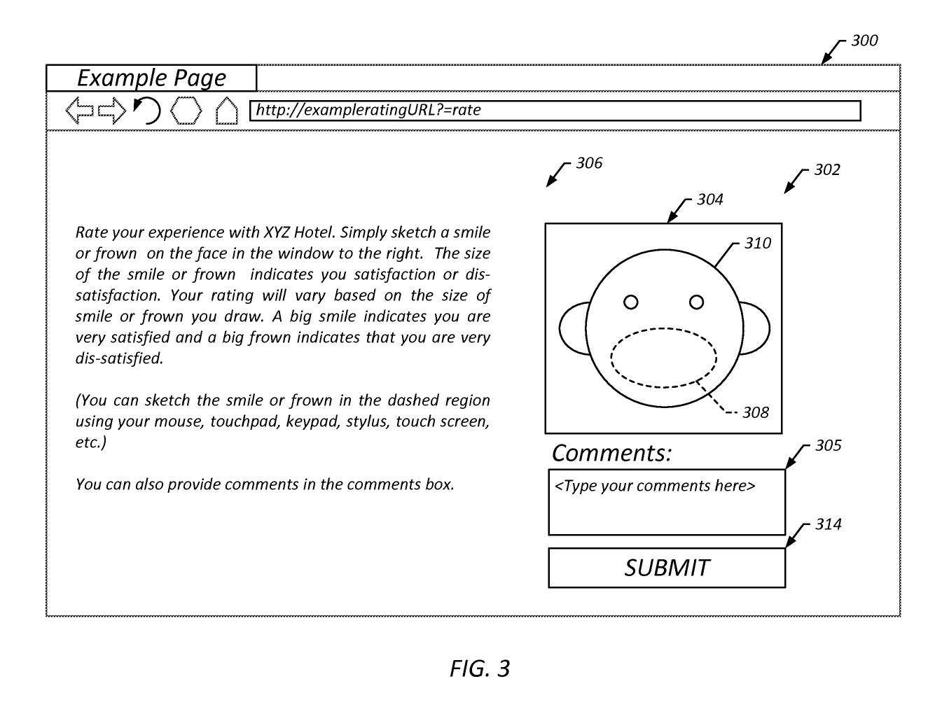

FIG. 3 is an illustration an exemplary webpage 300 including a gesture input interface in accordance with one or more embodiments of the present technique. Webpage 300 includes a rating input interface 302 that may be displayed to user 110 via a graphical user interface 112 of access device 104. In some embodiments, rating input interface 302 may include a gesture input region 304, a comments region 305 and/or instructions 306. Instructions 306 may instruct user 110 regarding how to provide a rating via rating input interface 302. For example, instructions 306 explain that gestures of a first type (e.g., a smile) indicate a satisfaction, whereas gestures of a second type (e.g., a frown) indicate dis-satisfaction. Instructions 306 may explain that rating levels will vary based on characteristics of the gesture drawn by the user. For example, a large smile may correspond to a higher level of satisfaction (i.e., a high rating), a small smile may correspond to a lower level of satisfaction, a large frown may correspond to a higher level of dis-satisfaction (i.e., a low rating), and a small frown may correspond to a lower level of dis-satisfaction. Instructions 306 may direct user 110 how to input rating information. For example, instruction 306 may explain that user 110 can sketch a smile/frown using a mouse, touchpad, keypad (e.g., arrow keys), stylus, touch screen, or the like. Instruction 306 may explain that a user can provide textual comments/reviews via comment box 305.

In some embodiments, gesture input region 304 includes a defined input area. For example, gesture input region 304 may include a defined gesture input area 308. Defined gesture input area 308 may correspond to an area in which a user may sketch or otherwise define a depiction of a gesture indicative of their rating for the given entity. For example, defined gesture input area 308 may include a mouth region in which the user is to sketch a smile or frown indicative of their rating of XYZ Hotel. In some embodiments, gesture input region 304 may be displayed to a user with a marked gesture input area 308. For example, gesture input region 304 may be displayed with a dashed oval defining gesture input area 308. In some embodiments, gesture input region 304 may be displayed to a user without a marked gesture input area 308. For example, gesture input region 304 may be displayed without a dashed oval defining gesture input area 308. Such an embodiment may enable increased user creativity by removing bounds associated with a defined input area.

In some embodiments, gesture input region 304 may include additional contextual information. For example, gesture rating input region 304 may contextual graphics such as face 310 which may aid a user's understanding of how to interact with the gesture input region 304. For example, where a non-English speaking/reading user cannot read instructions 306, the user may be able to decipher how to define a gesture based on the context of face 310. In some embodiments, gesture input region 304 may not include contextual graphics. For example, gesture input region 304 may be substantially or completely blank. Such an embodiment may enable increased user creativity by removing bounds associated with the contextual graphics.

In some embodiments, gesture input region 304 includes a free-form area in which a user may input a graphical representation of a gesture corresponding to a rating. For example, gesture input area 308 may include a region in which a user can provide a free-form sketch of various graphical representations of gestures, such as a curve representing a smile/frown.

FIGS. 4A-4F are illustrations of various graphical representations of gestures (e.g., expressions) in accordance with one or more embodiments of the present technique. Gesture 400a of FIG. 4A may be indicative of a very low rating corresponding to a high level of dis-satisfaction. Gesture 400b of FIG. 4B may be indicative of a low rating corresponding to a low level of dis-satisfaction. Gesture 400c of FIG. 4C may be indicative of a moderate rating corresponding to an indifferent level of satisfaction. Gesture 400d of FIG. 4D may be indicative of a high rating corresponding to a low level of satisfaction. Gesture 400e of FIG. 4E may be indicative of a higher rating corresponding to a high level of satisfaction. Gesture 400f of FIG. 4F may be indicative of a very high rating corresponding to a very high level of satisfaction. A user-defined graphical representation of a gesture (e.g., smile or frown) provided within gesture input region 304 may be similar to the varying levels of smiles and frowns depicted in FIGS. 4-4F.

In some embodiments, gesture input region 304 may include a pre-defined graphical representation of a gesture. In some embodiments, the pre-defined graphical representation of a gesture may be manipulated by a user to re-define the graphical representation of the gesture. The re-defined gesture may be submitted to rating system 102. For example, a line representing neither a smile nor a frown, similar to that of FIG. 4C, may be provided within gesture input region 304 (e.g., within gesture input area 308). User 110 may be able to manipulate the line into varying degrees of curvature to provide a graphical representation of a smile or frown corresponding to their rating of an entity. For example, where a line is provided, as depicted in FIG. 4C, user 110 may simply click-and-drag upward within gesture input region 304 to cause the line to curve upward into a smile, similar to that depicted in FIGS. 4D, 4E or 4F. Conversely, where a line is provided, as depicted in FIG. 4C, user 110 may simply click-and-drag downward within gesture rating input region 304 to cause the line to curve downward into a frown, similar to that depicted in FIGS. 4A or 4B.

Providing a pre-defined graphical representation of a gesture may enable users to define a gesture when a touchscreen or similar input device is not readily accessible. For example, a user can simply drag a pointer (e.g., using a mouse) across the screen to manipulate the gesture, as opposed to drawing a curve via device touchscreen interface. Further, a pre-defined graphical representation of a gesture may enable accurate comparisons between different gesture inputs, as the shapes may have pre-defined characteristics that simplify processing. For example, predefined gestures may eliminate stray user markings within gesture input region, eliminating the need for additional processing to filter stray marks from the provided gesture.

In some embodiments, a user may be provided a plurality of predefined graphical representations of gestures and may simply select a pre-defined graphical representation of a gesture to provide an indication of their rating. For example, user 110 may be presented with a display that includes each of the depictions of FIGS. 4A-4F, and may simply select one of the gestures to provide an indication of their rating (e.g., user 110 may select the gesture of 4F if they are want to provide an indication that they are very satisfied).

In some embodiments, selection of the “Submit” button 314 may cause submission of the user provided gesture. For example, selection of “submit” button 314 by user 110 may initiate transfer of gesture data (e.g., an image) representative of the graphical representation of a gesture provided by via gesture rating input region 304 to rating interface module 114 and/or rating module 120 for processing.

A gesture input interface may be provided in response to a request for a rating input interface. In some embodiments, a browser of access device 104 may request and receive from content provider 106, webpage 300, including a tag to embed rating input interface 302 within webpage 300 (e.g., a rating-tag). Upon rendering of webpage 300 and/or execution of the rating-tag, the browser may direct a request for rating input interface 302 to rating server 116 of rating system 102. Rating system 102 may process the request to identify and retrieve appropriate rating interface content for rating input interface 302 (e.g., HTML code and/or files for the corresponding rating input interface stored in datastore 118), and rating server 116 may provide the corresponding rating interface content to access device 104. The rating interface content may be rendered by the browser application to effectuate display of rating input interface 302 and/or webpage 300 via user interface 112 of access device 104.

In some embodiments, upon a browser of access device 104 requesting, from content provider 106, webpage 300, including rating input interface 302, content provider 106 may submit to rating server 116 of rating system 102, a request for rating interface content corresponding to rating input interface 302. Rating system 102 may process the request to identify appropriate rating interface content for rating input interface 302 (e.g., HTML code and/or files for the corresponding rating input interface), and rating server 116 may provide the corresponding rating interface content to content provider 106. Content provider 106 may embed the corresponding rating interface content into a webpage (e.g., an HTML file) 300, content provider 106 may forward the webpage 300 (including the rating interface content) to access device 104, and webpage 300 may be rendered by the browser application to effectuate display of webpage 300, including rating input interface 302, via user interface 112 of access device 104.

Method 200 may include receiving a gesture, as depicted at block 204. Receiving a gesture may include receiving a graphical representation of a gesture input by a user via a gesture input interface, as described with regard to block 202. For example, where providing a rating input interface includes display of a gesture input interface 302 and/or gesture input region 304, as discussed above with regard to FIG. 3, receiving a gesture may include receiving a graphical representation of a gesture (e.g., smile/frown) sketched or otherwise provided by user 110 via gesture input region 304. User 110 may free-form sketch a gesture, manipulate a predefined gesture to provide a graphical representation of a gesture, and/or select a predefined gesture, as described above. In some embodiments, when user 110 has completed the input of the gesture (e.g., via selection of the submit button 314 on webpage 300), data corresponding to the graphical representation of the gesture may be transmitted to access device 104 and/or rating system 102 for processing. In some embodiments, receiving a gesture may include receiving accompanying reviews/comments (e.g., textual comments provided via comment box 305).

Method 200 may include determining a rating corresponding to the gesture provided (e.g., a gesture rating), as depicted at block 206. Determining a rating corresponding to the gesture may include assessing the graphical representation of the gesture received to determine a corresponding rating value that corresponds to one or more attributes/features of the gesture. In some embodiments, a rating is based on one or more geometric features/attributes of a gesture. For example, where the gesture is a smile/frown, a rating may be based on a curvature, height, width, and/or angle of the gesture. A rating may be determined by any of the techniques described herein or any combination thereof.

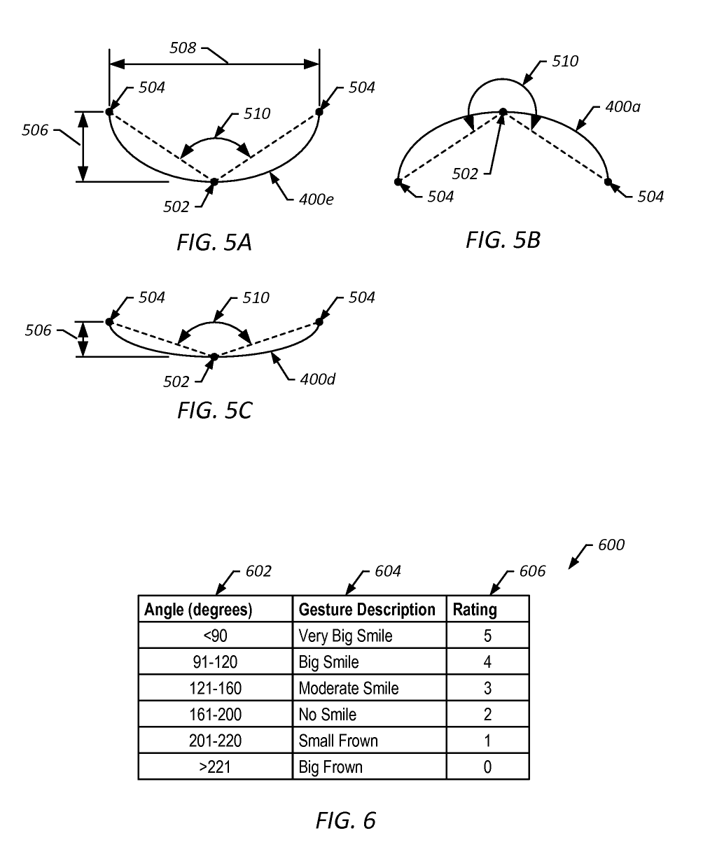

FIGS. 5A-5C are diagrams that illustrate exemplary geometric attributes of gestures 400e, 400a and 400d of FIGS. 4E, 4A and 4D, respectively, in accordance with one or more embodiments of the present technique. In some embodiments, for each of gestures 400e, 400a and 400d, an apex point 502 and two endpoints 504 are identified. The apex point 502 may be identified as the lowest or highest point of the gesture that occurs between the two endpoints 504. A height 506 of each of the gestures may be determined as the greatest, least or average vertical distance 506 between apex 502 and each of endpoints 504. In some embodiments, a concave curvature (e.g., corresponding to a smile) may be considered to have a positive height, whereas a convex curvature (e.g., corresponding to a frown) may have a negative height. A width 508 of each of the gestures may be the horizontal distance between endpoints 504. The width may also be defined as the greatest horizontal distance between any two points of the gesture. An angle 510 of each of the gestures may be determined as the angle formed between lines projected through the each of the two endpoints 504 and apex 502.

In the illustrated embodiment of FIG. 5A, gesture 400e has a height of about positive twelve millimeters (mm), a width of about fifty millimeters, and an angle of about one-hundred-ten degrees. In the illustrated embodiment of FIG. 5B, gesture 400a has a height of about negative twelve millimeters (mm), a width of about fifty millimeters, and an angle of about two-hundred sixty degrees. In the illustrated embodiment of FIG. 5C, gesture 400d has a height of about positive eight millimeters (mm), a width of about fifty millimeters, and an angle of about one-hundred forty degrees.

In some embodiments, a rating may be determined based upon a height of the gesture. The rating may correspond to the determined height of the given gesture. For example, gestures 400e, 400a and 400d may be determined to have ratings of “12”, “−12”, and “8”, respectively. A higher rating value may be indicative of a higher level of satisfaction, whereas a lower rating value may be indicative of a higher level of dissatisfaction (or at least a lower level of satisfaction).

In some embodiments, a rating may be determined based upon a width of the gesture. The rating may correspond to the determined width 508 of the given gesture. For example, gestures 400e, 400a and 400d may be determined to have ratings of “50”. A higher rating value may be indicative of a higher level of satisfaction, whereas a lower rating value may be indicative of a higher level of dissatisfaction (or at least a lower level of satisfaction).

In some embodiments, a rating may be determined based upon a combination of attributes. For a given gesture, the rating may correspond to a ratio of the determined height 506 to the determined width 508. For example, gestures 400e, 400a and 400d may be determined to have ratings of about “0.24” (e.g., 12 mm/50 mm), about “−0.24” (e.g., −12 mm/50 mm), and about “0.16” (e.g., 8 mm/50 mm), respectively. A higher rating value may be indicative of a higher level of satisfaction, whereas a lower rating value may be indicative of a higher level of dissatisfaction (or at least a lower level of satisfaction).

In some embodiments, a rating may be determined based upon angle of the gesture. For a given gesture, the rating may correspond to the determined angle 510. For example, gestures 400e, 400a and 400d may be determined to have a rating of about “110”, about “260”, and about “140”, respectively. A lower rating value may be indicative of a higher level of satisfaction, whereas a higher rating value may be indicative of a higher level of dissatisfaction (or at least a lower level of satisfaction).

In some embodiments, a rating is analog in nature (e.g., having any number of possible values). For example, a rating based on the angle may fall anywhere in the range of “0” and 360”. In some embodiments, a rating is based on a discrete range or increment of one or more attributes/characteristics. For example, gestures having a geometric characteristic/attribute value that fall within a given range of geometric characteristic/attribute values may be correlated with a given rating value that corresponds to the given range.

FIG. 6 depicts an index 600 specifying exemplary relationships (e.g., mappings) between geometric attributes, descriptions and rating values in accordance with one or more embodiments of the present technique. Index 600 specifies six discrete ranges of angles 602, along with a description of the gesture 604 and a gesture rating 606 mapped to each of the six discrete ranges. Based on index 600, gesture 400e (having an angle of about one-hundred-ten degrees) may be associated with a rating of “4” and a description of a “Big Smile”, gesture 400a (having an angle of about two-hundred sixty degrees) may be associated with a rating of “1” and a description of a “Big Frown”, and gesture 400d (having an angle of about one-hundred forty degrees) may be associated with a rating of “3” and a description of a “Moderate Smile”.

In some embodiments, relationships between characteristics/attributes of gestures and gesture ratings may be pre-defined. For example, index 600 or a similar mapping may be stored in a memory location, such as datastore 118 or a memory location of access device 104. In some embodiments, pre-defined criteria may be accessed and used for determining ratings. For example, an angle may be determined for a gesture, index 600 may be accessed to determine which of ranges 602 correspond to the determined angle, and a corresponding rating value may be associated with the gesture based on the determined range of index 600.

In some embodiments, a rating may be based on a plurality of different gestures and/or rating values. In some embodiments, where a plurality of gestures have been received the ratings for each of the gesture may be combined to provide a combined rating. For example, where gestures 400e, 400a and 400d of FIGS. 5A-5C have been received in association with ratings of XYZ Hotel, rating values of “4”, “1” and “3” may be determined for each of the respective gestures 400e, 400a and 400d based on their angles and the relationships defined by index 600. The individual rating values for each may be combined (e.g., averaged or some other combination thereof) to determine a combined rating of “2.67” (e.g., (4+1+3)/3). In some embodiments, the determined value of “2.67” may be rounded to provide a combined rating of “3”.

In some embodiments, geometric characteristics/attributes of gestures may be combined to provide a combined gesture from which a combined rating is determined. For example, where gestures 400e, 400a and 400d of FIGS. 5A-5C have been received by access device and/or rating system 102, rating interface module 114 and/or rating module 120 may determine angles of about one-hundred-ten degrees, two-hundred sixty degrees, and one-hundred forty degrees for the respective gestures 400e, 400a and 400d. The individual angles for each of the gestures may be combined (e.g., average or otherwise combined) to determine a combined angle of about one-hundred seventy degrees. A combined gesture rating may be based on the combined angle. For example, a combined rating of “2” may be assigned based on the combined angle of about one-hundred seventy degrees falling within the angle range of “161-200” of index 600.

In some embodiments, a combined rating may be based upon a combined geometric representation of a plurality of gestures. In some embodiments, where a plurality of gestures have been received, a combined geometric representation of the plurality of gestures may be generated. The combined geographic representation may be assessed to determine a corresponding rating. For example, where gestures 400e, 400a and 400d of FIGS. 5A-5C have been received by rating system 102, rating processing module 116b may apply curve fitting to determine a best-fit curve for a set of points defining the gestures. For the best-fit determination, each of apex points 502 may be aligned, and a best-fit curve may be generated based on the three apex points 502 and the six end points 504. The best-fit curve may be assessed to determine a corresponding rating. For example, a best-fit curve for the gestures 400e, 400a and 400d of FIGS. 5A-5C may be the same or similar to gesture 400d and, thus, may have a combined rating value of “3” and a description of a “Moderate Smile” based on the relationships defined by index 600.

In some embodiments, assessing the graphical representation of a gesture to determine a corresponding rating may be provided at an access device. For example, rating interface module 114 or a similar application of access device 104 may process the received gesture data to generate a corresponding rating that is subsequently transmitted to rating system 102. Such an embodiment may help to reduce data transferred to rating system 102. For example, one or more ratings (e.g., one or more numeric values) may be transmitted to rating system 102 as opposed to a set of data for one or more gestures (e.g., one or more images representative of the graphical representation of the one or more gestures). In some embodiments, assessing the graphical representation of the gesture to determine a corresponding gesture rating index may be provided by rating system 102 (e.g., rating interface module 120). For example, a set of data for one or more gestures ratings (e.g., one or more images representative of the graphical representation of the one or more gestures) may be transmitted from access device 104 to rating system 102 and rating module 120 may process the received data to generate a corresponding rating.

In some embodiments, gestures and/or ratings may be stored. For example, images of gestures received and/or rating values corresponding thereto may be stored in datastore 118 of rating system 102. In some embodiments, method 200 may be repeated for any number of users and entities to generate a database of gestures and/or ratings that correspond to any number of entities.

Method 200 is an exemplary embodiment of a method employed in accordance with techniques described herein. Method 200 may be may be modified to facilitate variations of its implementations and uses. Method 200 may be implemented in software, hardware, or a combination thereof. Some or all of method 200 may be implemented by rating interface module 114 and/or rating module 120. The order of method 200 may be changed, and various elements may be added, reordered, combined, omitted, modified, etc.

In some embodiments, a plurality of ratings may be combined to generate an overall rating or rating index. For example, where a plurality of ratings have been identified for a given entity, the plurality of ratings may be combined to generate a single rating for the given entity. In some embodiments, the ratings may include those associated with gesture based rating techniques and/or other rating techniques. For example, rating values based on gestures may be combined with rating values based on a five-star rating system, and so forth.

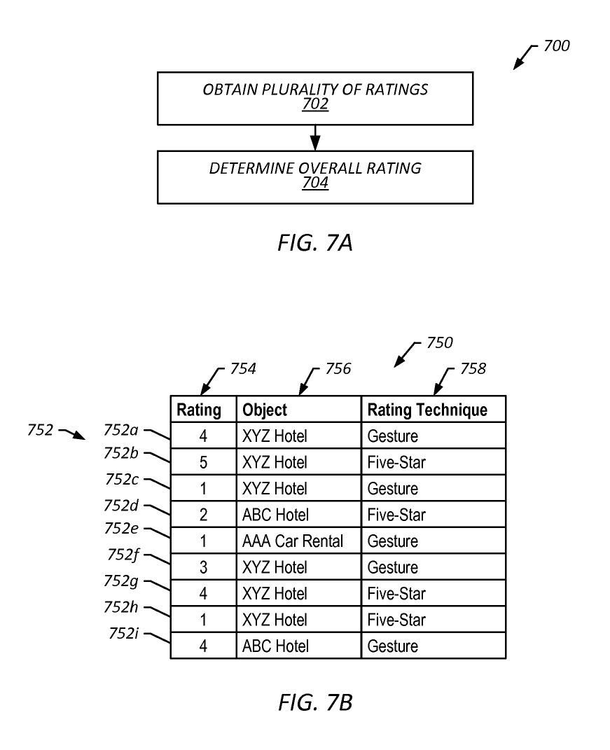

FIG. 7A is a flowchart that illustrates a method 700 of determining an overall (e.g., combined) rating in accordance with one or more embodiments of the present technique. Method 700 may generally include obtaining a plurality of ratings and determining an overall rating based on the plurality of ratings.

Method 700 may include obtaining a plurality of ratings, as depicted at block 702. In some embodiments, obtaining a plurality of ratings may include obtaining a plurality of gesture based rating values. For example, method 200 may be repeated for any number of user and entities to generate a database of gesture based ratings that correspond to any number of entities. In some embodiments, obtaining a plurality of ratings may include obtaining a plurality of rating values associated with other rating techniques (e.g., non-gesture based). For example, where a hotel is the subject of a rating, and ratings of “4”, “1” and “3” have been obtained using gesture based rating techniques, and ratings of “5”, “4” and “1” have been obtained using five-star rating techniques, obtaining a plurality of ratings for the hotel may include obtaining the ratings of “4”, “1”, “3”, “5”, “4” and “1”. FIG. 7B depicts an index 750 including ratings for a plurality of different entities obtained via different rating techniques in accordance with one or more embodiments of the present technique. Index 750 may include a plurality of entries 752 (e.g., entries 752a-752i) each listing a rating 754, a corresponding object/entity 756 and the rating technique 758 employed to obtain the corresponding rating. For example, entries 752a, 752c and 752f may corresponding to gesture ratings of “4”, “1” and “3” (e.g., corresponding to gestures 400e, 400a and 400d received) for XYZ Hotel that have been obtained using a gesture based rating technique, as discussed with regard to FIGS. 5A, 5B, 5C, FIG. 6 and method 200. Entries 752b, 752g and 752h may corresponding to gesture ratings of “5”, “4” and “1” for XYZ Hotel that have been obtained using a five-star based rating technique. In the illustrated embodiment, index 750 includes a table, although index 750 may include any suitable data format. In some embodiments, index 750 may be stored at datastore 118. index 750

Method 700 may include determining an overall rating, as depicted at block 704. Determining an overall rating may include determining a rating for a given entity based on two or more ratings for the given entity. For example, where XYZ Hotel is the subject of a rating to be provided, data of index 750 may be accessed to identify gesture based ratings of “4”, “3” and “1” for XYZ Hotel. The ratings may be combined (e.g., averaged or otherwise combined) to determine a combined gesture based rating of “2.67” (e.g., (4+1+3)/3) for XYZ Hotel. In some embodiments, the determined value of “2.67” may be rounded to provide an overall rating of “3”. In some embodiments, determining an overall rating index may include determining an overall rating based on gesture based ratings and/or ratings obtained using other rating techniques. For example, where XYZ Hotel is the subject of a rating to be provided, data of index 750 may be accesses to identify gesture based ratings of “4”, “1” and “3” for XYZ Hotel and five-star based ratings of “5”, “4” and “1” for XYZ Hotel may be combined (e.g., averaged or otherwise combined) to determine an overall gesture rating index of “3” (e.g., (4+1+3+5+4+1)/3) for XYZ Hotel. In some embodiments, the overall rating may be stored in datastore 118 of rating system 102.

It will be appreciated that method 700 is an exemplary embodiment of a method employed in accordance with techniques described herein. Method 700 may be may be modified to facilitate variations of its implementations and uses. Method 700 may be implemented in software, hardware, or a combination thereof. Some or all of method 700 may be implemented by overall rating module 116c. The order of method 700 may be changed, and various elements may be added, reordered, combined, omitted, modified, etc.

In some embodiments, rating information may be presented to a user or other entity of environment 100. For example, a gesture (e.g., a smile/frown) corresponding to a rating for a given entity may be provided for display to user 110, thereby enabling user 110 to quickly and easily determine whether other users have had a positive or negative experience with the particular entity. In some embodiments, rating information displayed to a user may include a gesture corresponding to an overall rating for an entity and/or gestures indicative of individual ratings for the entity.

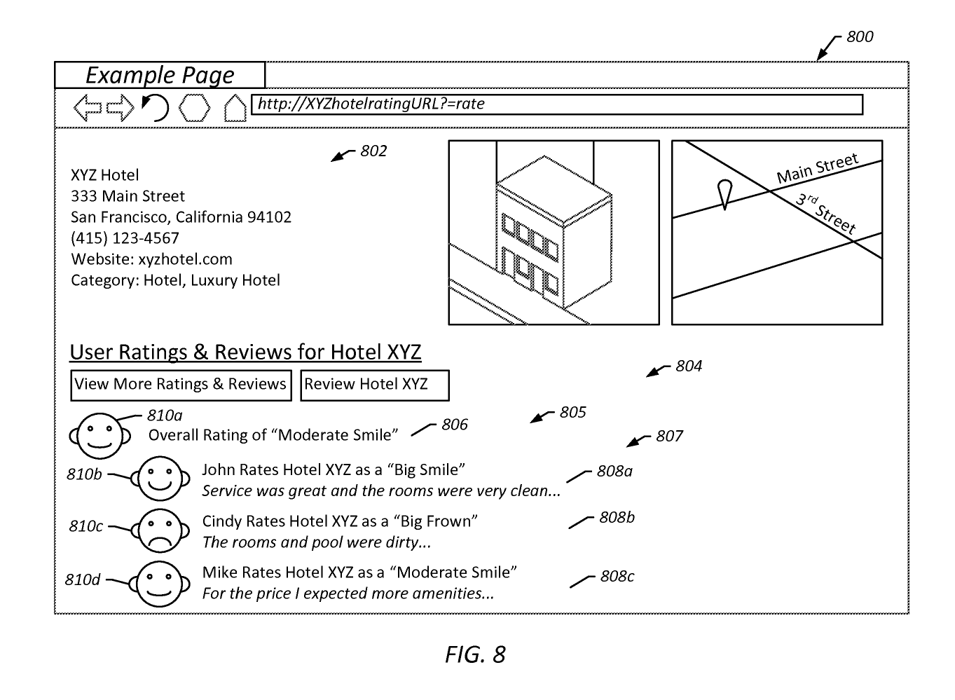

FIG. 8 illustrates an exemplary webpage 800 including rating information in accordance with one or more embodiments of the present technique. In some embodiments, webpage 800 may include a place page for XYZ Hotel that provides a general display region 802 including general information about the XYZ hotel (e.g., contact information, photographs, and a map) and a rating display region 804 that includes rating/review information (“rating information”) 805 corresponding to the XYZ Hotel. The rating information 805 may include an overall rating 806 and a listing of individual ratings/reviews 807. Overall rating 806 may correspond to an overall rating determined for XYZ Hotel (e.g., via method 700). For example, overall rating 806 may include a gesture rating 810a including a depiction of a “Moderate Smile” that corresponds to an overall rating having a value of “3”. The individual ratings/reviews 807 may correspond to one or more individual ratings received and/or their corresponding rating values. For example, individual ratings/reviews 807 may include gesture 810b, 810c and 810d corresponding to gesture ratings of “Big Smile”, “Big Frown”, and “Moderate Smile” that correspond to rating values of “4”, “0” and “3” for each of gestures 400e, 400a and 400d of FIGS. 5A-5B, respectively. Ratings/reviews 807 may include other rating information, such as textual comments 808a, 808b and 808c. In some embodiments, upon selection of the “Review Hotel XYZ” button displayed on webpage 800, webpage 300 of FIG. 3 may be displayed, thereby enabling a user to provide their own rating of Hotel XYZ.

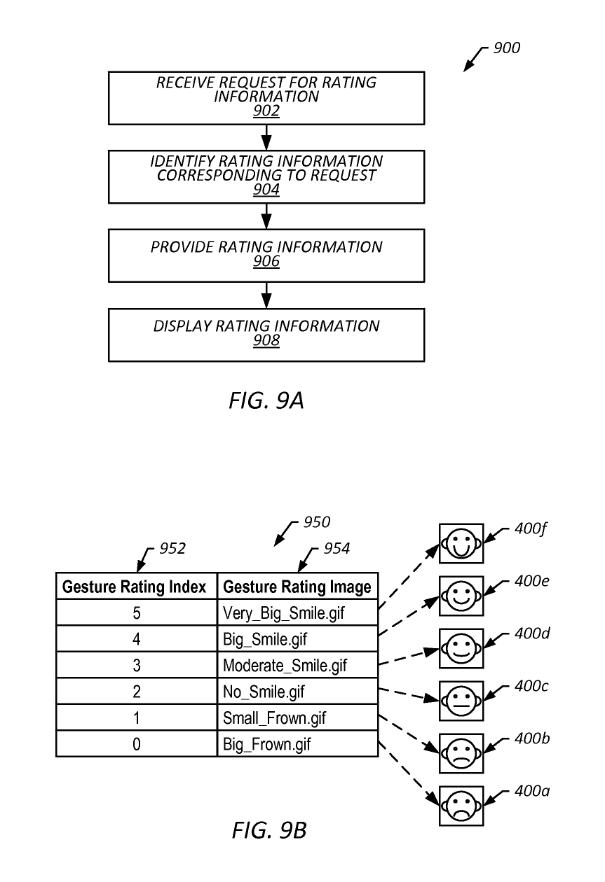

FIG. 9A is a flowchart that illustrates a method 900 of displaying rating information in accordance with one or more embodiments of the present technique. Method 900 may generally include receiving a request for rating information, identifying corresponding rating information, providing rating information, and displaying rating information.

Method 900 may include receiving a request for rating information, as depicted at block 902. Receiving a request for rating information may include receiving a user initiated request for rating information. In some embodiments, a request for rating information may include an identification of a corresponding entity (e.g., XYZ Hotel) for which rating information is to be provided. For example, a user may initiate a request to view webpage 800, including reviews for XYZ Hotel, via access device 104, and access device 104 may transmit a corresponding request for content (e.g., a request for webpage 800) to content provider 106. Content provider 106 may transmit a corresponding request for content (including the rating information) to rating server 116 of rating system 102. In some embodiments, content provider 102 may provide a webpage including a rating-tag (e.g., webpage 800 including a rating-tag to request rating information for XYZ Hotel) to access device 104. Upon a browser of access device 104 rendering the rating tag, the browser of access device 104 may transmit a request for rating information for XYZ Hotel to rating server 116 of rating system 102.

Method 900 may include identifying rating information corresponding to the received request, as depicted at block 904. Identifying rating information corresponding to the received request may include identifying rating information (e.g., a gesture, rating value or the like) corresponding to the given entity associated with the request. For example, where the request includes a request for rating information relating to XYZ Hotel, rating system 102 may identify one or more user provided gestures and/or ratings that correspond to XYZ Hotel. For example, rating system 102 may access data of index 750 to identify ratings of “4”, “1” and “3” for XYZ Hotel that have been obtained using gesture based rating techniques and/or ratings of “5”, “4” and “1” for XYZ Hotel that have been obtained using five-star rating techniques.

Method 900 may include providing rating information, as depicted at block 906. Providing rating information may include providing, to a requesting entity (e.g., content provider and/or access device 104), rating information identified at block 904. Providing rating information may include providing a gesture rating or other indicia of user ratings/reviews. In some embodiments, proving rating information may include providing gesture data (e.g., an image or other graphical data that may be rendered to provide for the display of a corresponding gesture). For example, with regard to XYZ Hotel, providing rating information may include providing image data that may be rendered to provide for display of gestures 810a-810d in webpage 800.

In some embodiments, a look-up table may be employed to identify a gesture/rating corresponding to a received rating value. FIG. 9B is a diagram that illustrates a gesture/rating look-up table (LUT) 950 in accordance with one or more embodiments of the present technique. LUT 950 may define a relationships between given rating value (e.g., ratings of “1” though “5”) and corresponding image files. Each of images 954 may correspond to a given one of gestures 400a-400f. For example, a rating value of “1” may correspond to an image of “Small_Frown.gif” corresponding to gesture 400b. Similar relationships may be defined for other ratings and gestures. In some embodiments, LUT 950 and/or corresponding image files 954 may be stored on or/or accessible by user access device 104. For example, LUT 950 and/or the gesture rating images may be stored on a memory of access device 104.

In some embodiments, LUT 950 may be employed to identify a gesture graphic to be displayed based on a received rating value. For example, where access device 104 receives webpage 800 indicating gesture ratings of rating of “3”, “4” “0” and “3” for ratings 806 and 808a-808c, respectively, access device 104 may access LUT 950 to identify gesture rating image files “Moderate_Smile.gif”, “Big_Smile.gif”, “Big_Frown.gif” and “Moderate_Smile.gif” corresponding to the respective ratings, and the gesture rating image files may be rendered within webpage 800 to provide for the display of gestures 810a, 810b, 810c, and 810d corresponding to gestures 400d, 400e, 400a and 400d, respectively, as depicted in webpage 800 of FIG. 8. Although the described exemplary embodiment include *.gif files, other embodiments may include any other form of files or data that may be render or otherwise processed to generate a visual depiction of a corresponding gesture rating.

Method 900 may include displaying rating information, as depicted at block 908. Displaying rating information may include displaying to a user, rating information including a graphical depiction of a gesture rating (e.g., a graphical representation of a gesture that is indicative of a rating). For example, a browser of access device 104 may render for displaying to user 110 via a graphical user interface 112 of access device 104, webpage 800 including rating information provided in rating display region 804.

It will be appreciated that method 900 is an exemplary embodiment of a method employed in accordance with techniques described herein. Method 900 may be may be modified to facilitate variations of its implementations and uses. Method 900 may be implemented in software, hardware, or a combination thereof. Some or all of method 900 may be implemented by rating interface module 114 and/or rating module 120. The order of method 900 may be changed, and various elements may be added, reordered, combined, omitted, modified, etc.

Exemplary Computer System

FIG. 10 is a diagram that illustrates an exemplary computer system 1000 in accordance with one or more embodiments of the present technique. Various portions of systems and methods described herein, may include or be executed on one or more computer systems similar to system 1000. For example, some or all of rating system 102, access device 104, and/or content provider 106 described herein may include a configuration similar to at least a portion of computer system 1000. Further, methods/processes/modules described herein may be executed by one or more processing systems similar to that of computer system 1000.

Computer system 1000 may include one or more processors (e.g., processors 1010a-1010n) coupled to memory 1020, an input/output I/O device interface 1030 and a network interface 1040 via an input/output (I/O) interface 1050. A processor may be any suitable processor capable of executing/performing instructions. A processor may include a central processing unit (CPU) that carries out program instructions to perform the basic arithmetical, logical, and input/output operations of computer system 1000. A processor may include code (e.g., processor firmware, a protocol stack, a database management system, an operating system, or a combination thereof) that creates an execution environment for program instructions. A processor may include a programmable processor. A processor may include general and/or special purpose microprocessors. A processor may receive instructions and data from a memory (e.g., system memory 1020). Computer system 1000 may be a uni-processor system including one processor (e.g., processor 1010a), or a multi-processor system including any number of suitable processors (e.g., 1010a-1010n). Multiple processors may be employed to provide for parallel and/or sequential execution of one or more portions of the techniques described herein. Processes and logic flows described herein may be performed by one or more programmable processors executing one or more computer programs to perform functions by operating on input data and generating corresponding output. Processes and logic flows described herein may be performed by, and apparatus can also be implemented as, special purpose logic circuitry, e.g., an FPGA (field programmable gate array) or an ASIC (application specific integrated circuit).

I/O device interface 1030 may provide an interface for connection of one or more I/O devices 1060 to computer system 1000. I/O devices may include any device that provides for receiving input (e.g., from a user) and/or providing output (e.g., to a user). I/O devices 1060 may include, for example, graphical user interface displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area (WAN), a cellular communications network or the like.

System memory 1020 may be configured to store program instructions 1100 and/or data 1110. Program instructions 1100 may be executable by a processor (e.g., one or more of processors 1010a-1010n) to implement one or more embodiments of the present technique. Instructions 1100 may include modules of computer program instructions for implementing one or more techniques described herein with regard to various processing modules. Program instructions may include a computer program (also known as a program, software, software application, script, or code). A computer program may be written in any form of programming language, including compiled or interpreted languages, or declarative/procedural languages. A computer program may include a unit suitable for use in a computing environment, including as a stand-alone program, a module, a component, a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a propagated signal and/or a non-transitory computer readable storage medium. A propagated signal may include an artificially generated signal (e.g., a machine generated electrical, optical, or electromagnetic signal) having encoded information embedded therein. The propagated signal may be transmitted by a suitable transmitter device to and/or received by a suitable receiver device. A non-transitory computer readable storage medium may include a machine readable storage device, a machine readable storage substrate, a memory device, or any combination thereof. Non-transitory computer readable storage medium may include, non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium may have program instructions stored thereon that are executable by a computer processor (e.g., one or more of processors 1010a-1010n) to cause the subject matter and the functional operations described herein (e.g., method steps described herein).

I/O interface 1050 may be configured to coordinate I/O traffic between processors 1010a-1010n, system memory 1020, network interface 1040, I/O devices 1060 and/or other peripheral devices. I/O interface 1050 may perform protocol, timing or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000, or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices and/or software that may perform or otherwise provide for the performance of the techniques described herein. For example, computer system 1000 may include a desktop computer, a laptop computer, a tablet computer, a server device, a client device, a mobile telephone, a personal digital assistant (PDA), a mobile audio or video player, a game console, a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” mean including, but not limited to. As used throughout this application, the singular forms “a”, “an” and “the” include plural referents unless the content clearly indicates otherwise. Thus, for example, reference to “an element” includes a combination of two or more elements. Unless specifically stated otherwise, as apparent from the discussion, it is appreciated that throughout this specification discussions utilizing terms such as “processing”, “computing”, “calculating”, “determining” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical electronic or magnetic quantities within memories, registers, or other information storage devices, transmission devices, or display devices of the special purpose computer or similar special purpose electronic processing/computing device.

1. A method, comprising:
receiving, from a remote rating server, with a mobile handset, content describing an entity for which a user is to provide a rating;
after receiving the content, providing a graphical user interface on a display screen of the mobile handset, the graphical user interface comprising a gesture input region and displaying at least some of the content to indicate that the user is to rate the entity by inputting a gesture in the gesture input region;
receiving, via the gesture input region, a free-form gesture entered by the user drawing at least one free-form line across a touchscreen of the mobile handset, the at least one free-form line expressing, at least in part, the user's rating of the entity;
determining, locally with the mobile handset, a rating for the entity based, at least in part, on aspects of the free-form line; and
sending the rating to the remote rating server.

2. The method of claim 1, wherein the gesture comprises a representation of a human facial expression and the free-form line includes a direction of curvature that indicates whether the rating is favorable.

3. The method of claim 1, wherein the gesture comprises a smile/frown, and wherein the free-form line gesture is part of a larger gesture that, when displayed, depicts a face, the face expressing the entirety of the user's rating of the entity.

4. The method of claim 1, wherein receiving a a gesture comprises receiving a graphical representation of a smile/frown, and wherein determining a rating corresponding to the graphical representation of the gesture comprises:
determining one or more geometric characteristics of the graphical representation of the smile/frown; and
determining a gesture rating corresponding to the one or more geometric characteristics of the graphical representation of the smile/frown such that the rating is based at least in part on one or more geometric characteristics of a graphical representation of a smile/frown received via a gesture input region.

5. The method of claim 1, wherein the gesture input region graphically depicts the free-form gesture entered by the user on the display screen of the mobile handset, such that the user can see the at least one free-form line.

6. The method of claim 1, wherein determining, locally with the mobile handset, the rating for the entity based, at least in part, on aspects of the free-form line comprises:
determining that the user has rated the entity favorably based, at least in part, on a curvature of the free-form line.

7. The method of claim 1, determining, locally with the mobile handset, the rating for the entity based, at least in part, on aspects of the free-form line comprises:
determining that the user has rated the entity favorably based, at least in part, on a width of the free-form line.

8. The method of claim 1, wherein determining, locally with the mobile handset, the rating for the entity based, at least in part, on aspects of the free-form line comprises:
identifying a geometric attribute of the gesture; and
determining a rating corresponding to the geometric attribute identified.

9. The method of claim 8, wherein determining a rating corresponding to the geometric attribute identified comprises assessing an index to identify a rating mapped to the geometric feature.

10. The method of claim 1, wherein determining, locally with the mobile handset, the rating for the entity based, at least in part, on aspects of the free-form line comprises:
determining that the user has rated the entity favorably based, at least in part, on the relative height of at least two points on the free-form line.

11. The method of claim 10, wherein determining that the user has rated the entity favorably based, at least in part, on the relative height of at least two points on the free-form line comprises:
determining that the user has rated the entity favorably based, at least in part, on the relative height of exactly three points on the free-form line.

12. The method of claim 1, wherein determining, locally with the mobile handset, the rating for the entity based, at least in part, on aspects of the free-form line comprises:
determining that the user has rated the entity favorably based, at least in part, on an angle of the free-form line.

13. The method of claim 12, wherein determining that the user has rated the entity favorably based, at least in part, on an angle of the free-form line comprises:
determining that the user has rated the entity favorably based, at least in part, on the angle of the free-form line and the width of the free-from line.

14. The method of claim 1, further comprising displaying, via the display screen of the mobile handset, a rating corresponding to the determined rating.

15. The method of claim 1, wherein determining, locally with the mobile handset, the rating for the entity based, at least in part, on aspects of the free-form line comprises:
determining that the user has rated the entity favorably based, at least in part, on an angle of the free-form line.

16. The method of claim 1, wherein determining, locally with the mobile handset, the rating for the entity based, at least in part, on aspects of the free-form line comprises:
determining that the user has rated the entity either favorably or unfavorably based, at least in part, on an angle of the free-form line, curvature of the free form line, and a width of the free-from line.

17. The method of claim 1, further comprising:
sending, to the remote rating server, a request for a rating of another entity; and
receiving a rating corresponding to the-other entity.

18. The method of claim 17, comprising displaying a graphical representation of the rating corresponding to the other entity.

19. A non-transitory computer readable storage medium having computer-executable program instructions stored thereon, that are executable by a computer to cause steps comprising:
receiving, from a remote rating server, with a mobile handset, a content describing an entity for which a user is to provide a rating;
after receiving the content, providing a graphical user interface on a display screen of the mobile handset, the graphical user interface comprising a gesture input region and displaying at least some of the content to indicate that the user is to rate the entity by inputting a gesture in the gesture input region;
receiving, via the gesture input region, a free-form gesture entered by the user drawing at least one free-form line across a touchscreen of the mobile handset, the at least one free-form line expressing, at least in part, the user's rating of the entity;
determining, with the mobile handset, a rating for the entity based, at least in part, on aspects of the free-form line; and
sending the rating to the remote rating server.

20. A rating system, comprising:
a processor;
a memory; and
a processing module stored on the memory, the processing module is configured to be executed by the processor to cause operations comprising:
receiving, from a remote rating server, with a mobile handset, content describing an entity for which a user is to provide a rating;
after receiving the content, providing a graphical user interface on a display screen of the mobile handset, the graphical user interface comprising a gesture input region and displaying at least some of the content to indicate that the user is to rate the entity by inputting a gesture in the gesture input region;
receiving, via the gesture input region, a free-form gesture entered by the user drawing at least one free-form line across a touchscreen of the mobile handset, the at least one free-form line expressing, at least in part, the user's rating of the entity;
determining, with the mobile handset, a rating for the entity based, at least in part, on aspects of the free-form line; and
sending the rating to the remote rating server.
